(19) United States
(12) Patent Application Publication
(10) Pub. No.: US 2009/0015660 A1
(43) Pub. Date: Jan. 15, 2009

(54) Virtual TV room service with interactive capabilities signaling

(75) Inventors: Ramakrishna Vedantham, Sunnyvale, CA (US); David Leon, Courbevoie (FR); Umesh Chandra, Mt.View, CA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/879,008

(22) Filed: Jul. 12, 2007

(51) Int. Cl. H04N 7/15

(52) U.S. Cl. 348/14.09; 348/E07.083

(57) ABSTRACT

A virtual TV room service configured with a virtual TV room session responsive to a unique session set-up protocol between participants in the virtual TV room session and a conference server unit hosting the virtual TV room service wherein the conference server unit is defined by a unique Session Initiation Protocol Uniform Resource Identifier formed by concatenating the public portion of the Session Initiation Protocol Uniform Resource Identifier signaled in the electronic server/program guide for the mobile TV channel and the private portion of the Session Initiation Protocol Uniform Resource Identifier unique to the virtual TV room community and arranged such that each of the participants in the virtual TV room session is watching the same mobile TV channel. The capabilities of media control that are available to the participants in the virtual TV room session are specified in an XML file configured for communication during the setting up of the virtual TV room session.

### TECHNICAL FIELD

The present invention relates generally to the concept of a Virtual TV room service and deals more particularly with the formation of a Virtual TV room.

The present invention also relates to signaling mechanisms for the set-up of Virtual TV room sessions.

The present invention also deals with multimedia session interactive capabilities signaling through which the media control capabilities of a multimedia content server is signaled to a participant in a multimedia session in a Virtual TV room.

### LIST OF ABBREVIATIONS

### 3GPP=3rd Generation Partnership Project

### 3GPP2=3rd Generation Partnership Project 2

### ASIC=Application Specific Integrated Circuit

### B3G Beyond 3rd Generation

### BAC=Browser And Content

### BCAST=Broadcast

### BCMCS=Broadcast Multicast Services

### BSC=Base Station Controller

BSS=Base station system
BTS=Base transceiver Station

### CCCP=Centralized Conference Control Protocol

### CDMA2000=Code Division Multiple Access 2000

### CN=Core Network

### DSP=Digital Signal Processor

### DVB-H=Digital Video Broadcast for Handhelds

### ESG=Electronic Service Guide

### ESP=Electronic Service Program

### FDMA=Frequency Division Multiple Access

### FEC=Forward Error Correction

### FPGA=Field Programmable Gate Array

GPRS=General packet Radio Service

### GSM=Global System for Mobile Communication

### HARQ=Hybrid Automatic Repeat Request

### HTTP=Hypertext Transfer Protocol

### IETF=Internet Engineering Task Force

### IMS=IP Multimedia Subsystem

### IP=Internet Protocol

### IPDC=Internet Protocol Data Cast

### IPTV=Internet Protocol Television

### MediaFLO=Media Forward Link Only

### MBMS: Multimedia Broadcast Multicast Service

### MCU=Multipoint Conferencing Unit

### MSS=Multimedia Messaging Service

### MSC=Mobile Switching Center

### MSS=Multimedia Streaming Service

### OFDM=Orthogonal Frequency Division Multiplexing

### OFDMA=Orthogonal Frequency Division Multiple Access

### OMA=Open Mobile Alliance

### P-T-M=Point-To-Multipoint

### P-T-P=Point-To-Point

### PSS=Packet-Switched Streaming

### RAM=Random Access Memory

### RAN=Radio Access Network

### RNC=Radio Network Controller

### RNS=Radio Network System

### RTCP=Real Time Control Protocol

### RTSP=Real Time Streaming Protocol

### SGSN=Serving GPRS Support Node

### SIP=Session Initiation Protocol

### SMS=Short Message Service

### TDMA=Time Division Multiple Access

### TRX=Tranciver

### UE=User Equipment

### UMTS=Universal Mobile Telecommunication System

### URI=Uniform Resource Indicator

### W-CDMA=Wideband Code Division Multiple Access

### XCON=Centralized Conferencing

### XHTML=Extensible Hyper Text Markup Language

### XML=Extensible Markup Language

### BACKGROUND OF THE INVENTION

MobileTV service is at the present day undergoing standardization and testing, and include for example, OMA BAC BCAST, 3GPP MBMS, 3GPP2 BCMCS, DVB-H, IPDC and MediaFLO among others well known to those skilled in the art. In addition to these services providing access to popular TV channels on the mobile devices, it is contemplated that the future MobileTV services will also provide interactive features.

Along with Mobile TV services, Mobile multimedia sharing applications are also becoming more popular due in part to the availability of technologies such as, for example, efficient media codecs, powerful mobile processors, inexpensive fast memory, high speed 3G networks, and user-friendly mobile terminals and services.

Present day and future mobile terminals are contemplated to have access to both MobileTV channels as well as interactive channels. With mobility and interaction added to the traditional TV service, many innovative services are becoming possible that will lead to the service providers to compete with one another to offer innovative service packages to the MobileTV consumer.

One such innovative service package for MobileTV viewers is the concept of a Virtual TV Room service. In this concept, the participants of the Virtual TV Room service are geographically located at different places, however they would watch the same MobileTV channel, and a Virtual TV Room would be created by multimedia interaction among the participants. The multimedia interaction may range for example, from the most basic text chatting to live audio/video conferencing to media conferencing. The user experience would be further enriched by enabling all types of mobile multimedia sharing, while each user watches the same TV channel on his/her respective MobileTV. The effect is that all the participants would have the same experience as though they were all physically present at the same time in the same room.

What is needed therefore is a Virtual TV room service and a signaling mechanism to form the Virtual TV room sessions and to carry out the operational interactive and media control features of the Virtual TV room service.

### SUMMARY OF THE INVENTION

In a broad aspect of the invention, a virtual TV room service is configured with a virtual TV room session responsive to a unique set-up session protocol between participants in the virtual TV room session and a conference server unit hosting the virtual TV room service. The conference server unit is defined by a unique Session Initiation Protocol Uniform Resource Identifier formed by concatenating the public portion of the Session Initiation Protocol Uniform Resource Identifier signaled in the electronic server/program guide for the mobile TV channel and the private portion of the Session Initiation Protocol Uniform Resource Identifier unique to the virtual TV room community. The virtual TV room is arranged such that each of the participants in the virtual TV room session is watching the same mobile TV channel.

In another aspect of the invention, the capabilities of media control that are available to the participants in the virtual TV room session are specified in an XML file configured for communication during the setting up of the virtual TV room session.

In a further aspect of the invention, personal multi-media content is shared with the other participants in the virtual TV room session.

### BRIEF DESCRIPTION OF THE DRAWINGS

Other objects, features and advantages of the present invention will become readily apparent from the written description taken in conjunction with the drawings wherein:

FIG. 1 is a schematic functional block diagram of a first example of a Virtual TV Room service.

FIG. 2 is a flowchart showing the major functional steps in setting up a Virtual TV Room.

FIG. 3 is a schematic functional diagram of another example of Virtual TV Room service.

FIG. 4 is a schematic functional diagram of a further example of a Virtual TV Room service.

FIG. 5 is a schematic functional diagram of a further example of a Virtual TV Room service.

FIG. 6 is a schematic functional diagram of a yet further example of a Virtual TV Room service.

FIG. 7 is a schematic functional diagram showing an example of a number of Virtual TV Room communities.

FIG. 8 is a functional block diagram of an example of a signal processor for carrying out the invention.

FIG. 9 is a functional block diagram of an example of a UE or mobile terminal for carrying out the invention.

FIG. 10 is a block diagram/flow diagram of a wireless communication system in which the present invention may be implemented.

FIG. 11 is a reduced block diagram (only portions relevant to the invention being shown) of the UE terminal or the wireless terminal of FIG. 10.

FIG. 12 is a reduced block diagram of two communications terminals of FIG. 10 in terms of a multi-layered communication protocol stack.

FIG. 13 is a reduced block diagram of the user equipment terminal and the wireless terminal of the radio access network in terms of functional blocks corresponding to hardware equipment used in sending and receiving communication signals over an air interface communication channel linking the two communications terminals.

### DETAILED DESCRIPTION OF THE VARIOUS EXEMPLARY EMBODIMENTS

The following examples of the invention as described herein are explained with reference to MobileTV viewers as the participants of a Virtual TV Room session. However, the present invention is equally applicable to devices that have IP connectivity and have a SIP stack running on them, for example, IPTV. In addition, some participants of a Virtual TV Room session do not need MobileTV or IPTV reception capability at all. Therefore, the present invention is disclosed by way of example in the following description.

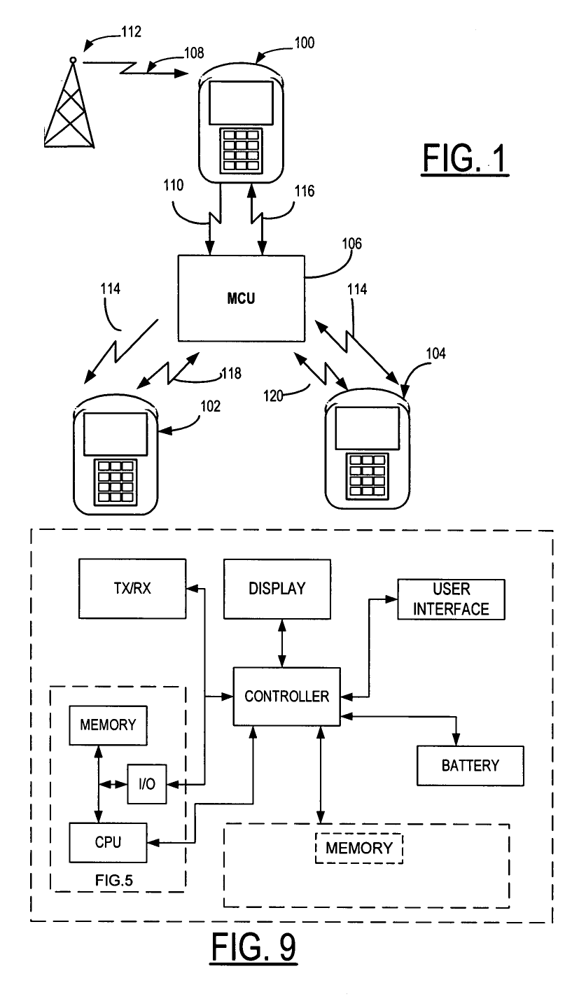

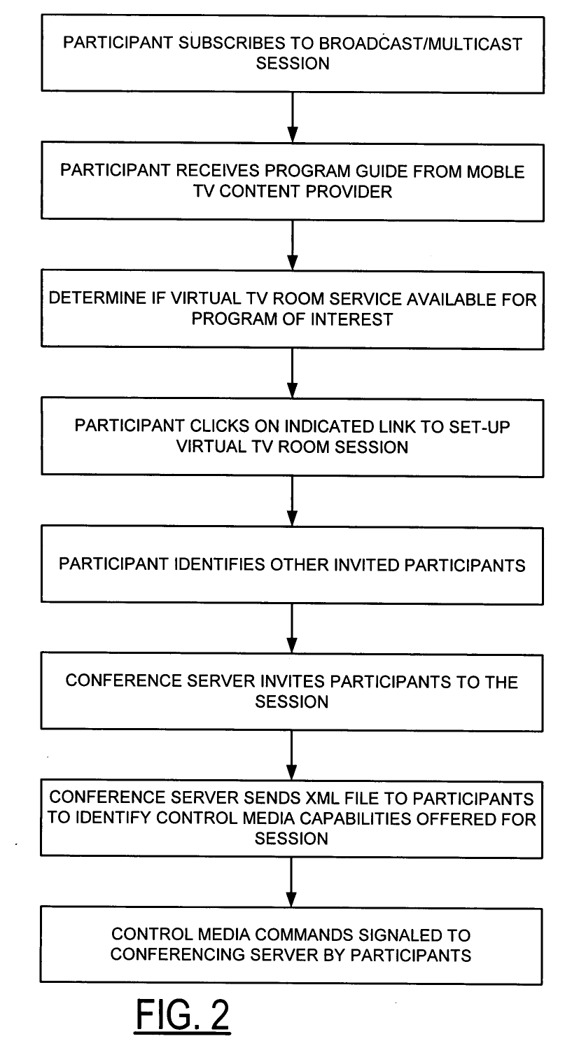

The Virtual TV room concept embodying the present invention is generally illustrated and described with reference to FIGS. 1 and 2 to provide an overview summary to assist in gaining a better understanding of the present invention. Multiple participants 100, 102, 104 each having a suitably arranged and configured mobile device join one another via a suitably arranged and configured conference/media server 106 to set-up the session.

In this session, the participants share not only the real time audio/video/chat or other personal multimedia content, but in addition, one of the participants 100 shares a TV broadcast content 110. In this instance, the participant 100 has a subscription to Mobile TV services (MBMS, BCMCS, etc.) 108 sent by a suitable broadcast/multicast sender 112, for example mobile TV, satellite, cable, etc. For some programs which happen to be popular, the TV provider may offer Virtual TV service for the program (the specifics of how the mobile TV operator indicates the availability of a Virtual TV room service with a telecast is not necessary to gain an understanding of the Virtual TV room service embodying the present invention but is mentioned herein to illustrate another example of an innovative service that may be offered with the Virtual TV room service of the present invention).

The participant 100 who is receiving the broadcast content 108 or who wishes to share recorded content that is stored on his mobile device sets up the session with the conference server 106 in a suitable manner and provides the conference server with the list of participants 102, 104 whom the conference/media server 106 needs to invite to the session being set up. The conference server then sends out the invitation message to each of the participants 102, 104 to join the session.

Once the session is set-up, the conference/media server 106 sends as an output stream 114, the TV content received by the participant 100 to the participants 102, 104 after participants 102 and 104 joined in the conference. Each participant 100, 102, 104 may also send an audio/video stream 116, 118, 120 to the conference server 106, and every participant can choose whom they wish to view (and hear) along with the TV content. In this manner, all the participants 100, 102, 104 see the same TV content and share their thoughts in real time audio/video even though they are geographically distributed in different physical locations. The participants experience a feeling of watching the TV content in the same room, thus forming and creating a Virtual TV room.

A participant may also share a live content that he is receiving on his mobile phone with the other participants. The conference server 106 takes the live content as input from the content provider, and in turn distributes the live content to all the other participants of the conference in a point-to-point fashion.

The conference server also signals during the session set-up phase with other participants, the media control capabilities that the conference server is going to provide during the session for the live TV content so that the participants can control the live TV session and have a real-time audio/video session with the other participants. Such signalling can be implemented using, for example XML files.

The Virtual TV Room service concept of the present invention is now considered in further detail. It should be noted that current OMA BCAST ESG specifications do not define Virtual TV Room service. The concept of the Virtual TV Room service of the present invention defines Virtual TV Room Service as a separate OMA BCAST Service. In order to do so, the existing mechanisms in OMA BCAST ESG require extensions to support fast set-up of Virtual TV room sessions. In accordance with the present invention a Virtual TV Room session is set-up based on simple extensions to the existing OMA BCAST ESG specifications.

The current release OMA BAC BCAST specifications, specify a service enabler identified as ESG to signal the metadata associated with various MobileTV services and mobile data broadcast/multicast services. This metadata is divided into various ESG fragments according to a service guide data model. The fragments are identified as “Service”, “Schedule”, “Content”, “Access”, “Session Description”, “Purchase Item”, “Purchase Data”, “Purchase Channel”, “Service Guide Context”, “Service Guide Delivery Descriptor”, “InteractivityData” and “Preview Data”. Of these ESG fragments, the “InteractivityData” fragment, the “Service” fragment and the “Access” fragment are used in the present invention for the Virtual TV Room service and are explained in the following.

The “InteractivityData” fragment is used to associate services and/or individual pieces of content of the services with interactivity components of service/content consumption. These interactivity components are used by the terminal to offer interactive services to the user possibly in parallel with the ‘regular’ broadcast content. These interactivity services enable users to e.g. vote during TV shows or to obtain content related to the ‘regular’ broadcast content. Whereas the ‘InteractivityData’ fragment can be thought to declare the availability of the interactivity components, the details of the components are provided via one or many InteractivityMediaDocuments, available at

http://member.openmobilealliance.org/ftp/Public documents/bcast/Perm anent documents/OMA-TS-BCAST Services-V10-20070529-C.zip, section 5.3.6.1) which may include XHTML files, static images, email template, SMS template, MMS template documents, etc. It has the following relevant attribute that is relevant to the current invention.

| | | | | | |
|---|---|---|---|---|---|
| InteractiveDelivery | E1 | NO/TM | 0 . . . 1 | This element indicates the possibility to receive | |
| | | | | InteractivityMedia over the interaction channel. | |
| | | | | Interactivity Media can either be pushed, using | |
| | | | | OMA PUSH delivery, or pulled, using HTTP | |
| | | | | requests to InteractivityMediaURL. If this | |
| | | | | element is present, at least one of PushDelivery | |
| | | | | and InteractivityMediaURL shall be included. | |
| | | | | Contains the following attributes: | |
| | | | | interactivtyMediaURL | |
| | | | | pushDelivery | |
| Interactivty | A | NO/TM | 0 . . . 1 | URL from which Interactivity Media can be | anyURL |
| MediaURL | | | | retrieved. The Content-Type SHALL be | |
| | | | | “multipart/mixed” in the HTTP response. | |

The “Access” fragment describes to the terminal how the terminal can access a service during the lifespan of the access fragment. The elements defined in the “Access” fragment are shown in the following chart.

| | | | | | |
|---|---|---|---|---|---|
| AccessType | E1 | NM/ | 1 | Defines the type of access. | |
| | | TM | | Contains the following attribute: | |
| | | | | TransmissionMedia | |
| | | | | Contains the following elements: | |
| | | | | BroadcastTransmission | |
| | | | | InteractiveTransmissionScheme | |
| TransmissionMedia | A | NM/ | 1 | This attribute indicates which channel is | integer |
| | | TM | | used for the delivery of service. | |
| | | | | 0: Broadcast Channel | |
| | | | | 1: Interaction Channel | |
| BroadcastTransmission | E2 | NO/ | 0 . . . 1 | This element is used for the indication | |
| | | TM | | of IP transmission. | |
| | | | | Contains the following attribute: | |
| | | | | IpAddress | |
| | | | | Contains the following elements: | |
| | | | | SessionDescription Reference | |
| | | | | SDP | |

The elements defined in the “Access” fragment to support access to the service through an Interaction Channel are shown in the following chart.

| | | | | | |
|---|---|---|---|---|---|
| InteractiveTransmissionScheme | E2 | NO/ | 0 . . . 1 | This element indicates which | |
| | | TM | | communication system or protocol is | |
| | | | | used for Interaction Channel. | |
| | | | | Containing the following attribute: | |
| | | | | TansmissionSchemeType | |
| | | | | Contains the following elements: | |
| | | | | AccessServerIpAddress | |
| | | | | AccessServerURL | |
| | | | | AccessServerPhoneNumber | |
| TransmissionSchemeType | A | NM/ | 1 | 1: Interaction Channel provided by | Integer |
| | | TM | | Interaction network | |
| | | | | 2: MMS | |
| | | | | 3: WAP 1.0 | |
| | | | | 4: WAP 2.x | |
| | | | | 5: SMS | |
| | | | | 6: HTTP | |
| | | | | 7: Voice Call | |
| | | | | 8: Service Provider defined | |
| | | | | Transmission Scheme | |
| | | | | Note: Other protocol or communication | |
| | | | | system May be added based on OMA | |
| | | | | Service interaction function. | |
| AccessServerIpAddress | E3 | NO/ | 0 . . . N | IP address of Sever, which provides | String |
| | | TM | | different access(over Interaction | |
| | | | | Channel) of a Service | |
| AccessServerURL | E3 | NO/ | 0 . . . N | ULR of Server, which provides | anyURI |
| | | TM | | different access (over Interaction | |
| | | | | Channel) of a Service | |
| AccessServerPhoneNumber | E3 | NO/ | 0 . . . N | Phone number of Server, which | integer |
| | | TM | | provides different access (over | |
| | | | | Interaction Channel) of a Service, | |
| | | | | Note: MMS and SMS use phone | |
| | | | | number as an address. | |

The following attribute, which is also defined in the “Access” fragment is relevant to the present invention and is shown in the following chart.

| | | | | |
|---|---|---|---|---|
| PrivateExt | E1 | NO/ | 0 . . . 1 | An element serving as a container for proprietary or |
| | | TO | | application-specific extensions. |
| <proprietary | E2 | NO/TO | 0 . . . N | Proprietary or application-specific elements that are not |
| elements> | | | | defined in this specification. These elements may further |
| | | | | contain sub-elements or attributes. |

The “Service” fragment describes at an aggregate level the content items which comprise a broadcast service. The service may be delivered to the user using multiple means of access, for example, the broadcast channel and the interactive channel. The Service may be targeted at a certain user group or geographical area. Depending on the terminal capabilities and the type of Service, the “Service” fragment may or may not have interactive part(s) as well as broadcast-only part(s).

The “Service” fragment has an attribute “ServiceType”, defined as follows. This “ServiceType” attribute may be used to define the new “Virtual TV Room” service.

| | | | | | |
|---|---|---|---|---|---|
| ServiceType | E1 | NM/ | 0 . . . N | Type of the service. | Unsigned |
| | | TM | | Allowed values are: | Byte |
| | | | | 0 - unspecified | |
| | | | | 1 - Basic TV | |
| | | | | 2 - Basic Radio | |
| | | | | 3 - RI services | |
| | | | | 4 - Cachecast | |
| | | | | 5 - File download services | |
| | | | | 6 - Software management services | |
| | | | | 7 - Notification | |
| | | | | 8 - Service Guide | |
| | | | | 9 - Terminal Provisioning services | |
| | | | | 10-27 reserved for future use | |
| | | | | 128-255 reserved for proprietary use | |
| | | | | The mixed service types SHALL be indicated by | |
| | | | | the presence of multiple instances of ServiceType | |
| | | | | (for example, for mixed Basic TV and Cachecast, | |
| | | | | two instances of ServiceType, with values 1 and | |
| | | | | 4 are present for this ‘Service’ fragment. | |
| | | | | This element SHALL be processed by the | |
| | | | | terminal strictly for rendering to the user for | |
| | | | | example as a textual indicator, an icon, or graphic | |
| | | | | representation for the service. However, | |
| | | | | ‘ServiceType’ with value of 3 and 9 SHALL | |
| | | | | NOT be rendered and their existence SHOULD | |
| | | | | NOT be displayed to the user. | |
| | | | | With value 6, i.e. sofware management services, | |
| | | | | users can select the desired software components | |
| | | | | (eg. desktop theme, ringtone, SG navigator | |
| | | | | update) to download over broadcast channel or | |
| | | | | interaction channel. The software components | |
| | | | | provided by this sofware management service are | |
| | | | | described by ‘Content’ fragments which belong | |
| | | | | to this ‘Service’ fragment. It is not expected that | |
| | | | | terminals are able to automatically select and | |
| | | | | download software components using this type of | |
| | | | | service. | |

The “Service” fragment has the following attribute shown in the chart below to describe additional information related to the service.

| | | | | |
|---|---|---|---|---|
| PrivateExt | E1 | NO/ | 0 . . . 1 | An element serving as a container for proprietary or |
| | | TO | | application-specific extensions. |
| <proprietary | E2 | NO/TO | 0 . . . N | Proprietary or application-specific elements that are not |
| elements> | | | | defined in this specification. These elements may further |
| | | | | contain sub-elements or attributes. |

The sub-element interactivtyMediaURL, of the element InteractiveDelivery of the InteractivityData fragment is set as the SIP URI of the conference server/MCU that hosts the Virtual TV Room service.

The group of MobileTV terminals that wish to establish a Virtual TV Room session establish a SIP session with the conference server/MCU and communicate with the MCU using the standard conference control protocols such as, for example, CCCP. However, this approach encounters longer than desired session set-up times because each member of the group of MobileTV viewers attempting to set up a Virtual TV Room session have no idea about the identification of the specific channel being watched by the other member or members of the group. This situation requires additional SIP signaling with the conferencing server or other suitable signaling among the members to make sure they are watching the same TV channel. Although the above approach implements the concept of the Virtual TV Room service of the invention, the process results in an undesirable long session set-up delay.

To reduce the session set-up time, additional information on the Virtual TV Room Service is defined in the web pages referred to by the PrivateExt element of the Service fragment. Additional information on how to join the Virtual TV Room Service is also defined in the web page referred to by the PrivateExt element of the Access fragment. For example, when the user clicks on the PrivateExt corresponding to a Virtual TV Room service of a MobileTV channel, a web page/form/GUI would pop-up. This web page may for example: (1) show the availability of the VirtualTV Room service; (2) show the existing participants of the VirtualTV Room; (3) prompt the user to enter the identities (for example, SIP URI's, phone numbers, etc.) of the users he/she wants to invite to the Virtual TV Room session; and (4) show other parameters relevant to the Virtual TV Room. This approach requires many details to be specified in the web pages referred by the PrivateExt elements of these ESG fragments and is further described below.

The electronic service guide that currently displays details of the scheduled MobileTV programs would be modified in accordance with the invention to display the existence of Virtual TV Room service associated with each corresponding MobileTV channel. If the user has a subscription to a Virtual TV Room service, an icon/tab to the associated interactive service is displayed next to the program information. The user joins a Virtual TV Room by clicking on this icon when the Virtual TV Room service is identified and available.

The Virtual TV Room participants form a SIP session among themselves through a conference server using a unique SIP URI of the conference server that hosts the Virtual TV Room service.

The unique SIP URI of the conference server is made up of two sections identified as “public” and “private” and is formed by concatenating the “public” and “private” sections. The “public” section of the SIP URI is always signaled in the Electronic Service Guide/Electronic Program Guide (ESG/EPG) for each MobileTV program. For example, the “public” section may be signaled in the Access fragment of the OMA BCAST ESG. The “public” section of the SIP URI by itself is a common pre-fix of the SIP URI for all Virtual TV Room sessions corresponding to a MobileTV channel. The “private” section of the SIP URI is unique to each Virtual TV Room community and may already be present or exist in the MobileTV terminals of the participants of the Virtual TV Room or may be signaled by other suitable signaling means.

A Virtual TV Room service and the use of the “public” and “private” sections of the unique SIP URI are illustrated in the following illustrative examples of the present invention wherein In the following examples, M1, M2, M3 are the participants of the Virtual TV room session formed via a conference server MCU.

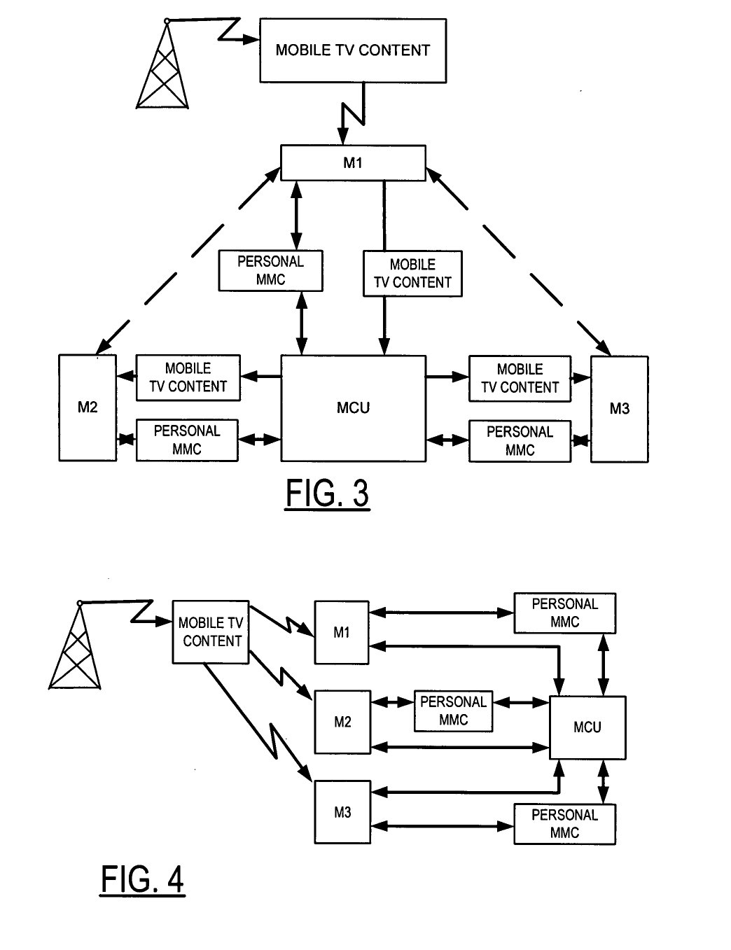

A first example is presented with reference to FIG. 3 showing a multi-point conferencing unit configured and arranged for forwarding the Mobile TV content received by a single participant from a broadcast/multicast source to the other participants and for sharing personal multimedia content among and between the participants in the Virtual TV room. In this example, participants M1, M2, M3 receive the ESG with the “public” section of the SIP URI of the MCU. Participant M1 asks participants M2 and M3 (using out-of band mechanisms, for example, SMS) to join the conference related to this TV channel. Participants M1, M2, M3 have previously obtained or received in a suitable manner the “private” section of the SIP URI of MCU. Participants M1, M2, and M3 now form the complete SIP URI of the MCU by concatenating the “public” and “private” sections and join the private conference through the MCU. Participant M1 now shares with the other participants M2 and M3 the mobileTV content received by participant M1 in the following manner. Participant M1 is the only one to tune-into the mobileTV channel and in turn then sends the mobileTV content to the MCU in unicast mode. Participants M2 and M3 now receive the mobileTV content from the MCU.

The participants M1, M2, M3 may also share their personal multimedia content with each other through the MCU in addition to receiving the mobile TV content. Such personal multimedia content may consist of, for example, live a/v feed, stored a/v clips, etc. or other such multimedia content well known to those skilled in the art.

The MCU may mix and format the incoming content (mobileTV content from M1 and personal media content received from participants M1, M2, M3) in any suitable and desirable layout.

A second example is presented with reference to FIG. 4, showing a multi-point conferencing unit configured and arranged for conferencing the participants for sharing personal multimedia content among and between the participants in the Virtual TV Room each of which receives the same Mobile TV content from a broadcast/multicast source. In this example, participants M1, M2, M3 receive the ESG with the “public” section of the SIP URI of the MCU. Participants M1, M2, M3 have previously obtained or received in a suitable manner the “private” section of the SIP URI of the MCU. Participants M1, M2, and M3 now form the complete SIP URI of the MCU by concatenating the “public” and “private” sections and join the private conference through the MCU. In this example, participants M1, M2, M3 all tune into the same mobileTV channel.

The participants M1, M2, M3 may also share their personal multimedia content with each other through the MCU in addition to receiving the mobile TV content. Such personal multimedia content may consist of, for example, live a/v feed, stored a/v clips, etc. or other such multimedia content well known to those skilled in the art.

The MCU may mix and format the incoming content (personal media content received from participants M1, M2, M3) in any suitable and desirable layout.

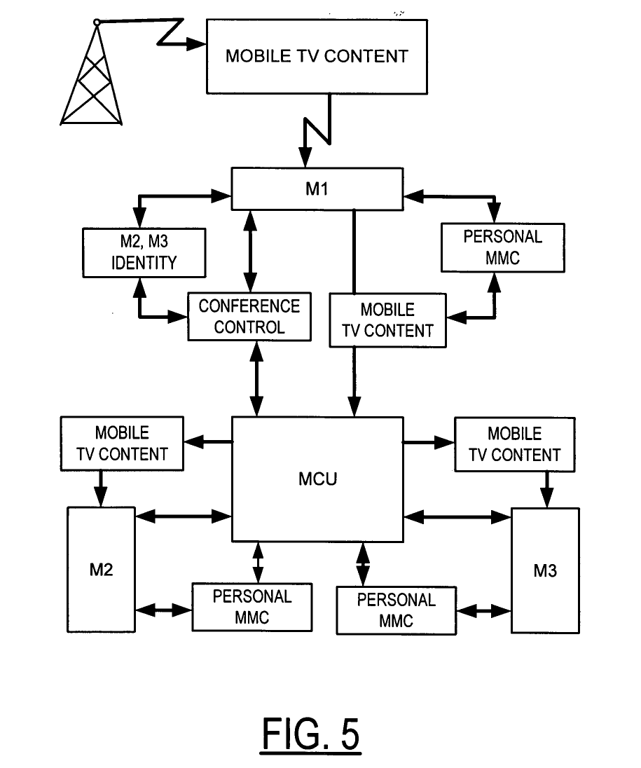

A third example is presented with reference to FIG. 5, showing a multi-point conferencing unit configured and arranged for inviting participants identified by a single participant and forwarding the Mobile TV content received by the single participant from a broadcast/multicast source to the other identified participants and for sharing personal multimedia content among and between the participants in the Virtual TV room. In this example, participant M1 receives the ESG with the “public” section of the SIP URI of the MCU and has previously obtained or received in a suitable manner the “private” section of the SIP URI of the MCU.

Participant M1 then forms the complete SIP URI of the MCU by concatenating the “public” and “private” sections. Participant M1 now selects the SIP URI's of participant's M2 and M3 from M1's address book. Participant M1 interacts with the MCU in a suitable manner to set up a SIP session with participants M2 and M3 and conveys the required information to the MCU by using conference control protocols such as, for example, CCCP.

The required information provided to the MCU may include for example, the identities of participants M2 and M3 (e.g. the SIP URI's of M2, M3), the start-time and end-time of the Virtual TV Room session, etc. and other appropriate information as necessary to set up the SIP session. Participant M1 may also convey this information to the MCU by any other suitable means to carry out the intended function such as, for example, by uploading this information via HTTP to a server, which in turn relays this information to the MCU. Participant M1 may also convey this information to the MCU via interaction schemes that are proprietary to the service provider network.

The MCU then invites participants M2 and M3 to join the session and participants M1, M2, M3 now become part of a private conference through the MCU.

Participant M1 now shares the mobileTV content received by it with participants M2 and M3 in the following manner.

Participant M1 is the only one to tune-into the mobileTV channel and in turn then sends the mobileTV content to the MCU in unicast mode. Participants M2 and M3 now receive the mobileTV content from the MCU.

The participants M1, M2, M3 may also share their personal multimedia content with each other through the MCU in addition to receiving the mobile TV content. Such personal multimedia content may consist of, for example, live a/v feed, stored a/v clips, etc. or other such multimedia content well known to those skilled in the art.

The MCU may mix and format the incoming content (mobileTV content from M1 and personal media content received from participants M1, M2, M3) in any suitable and desirable layout.

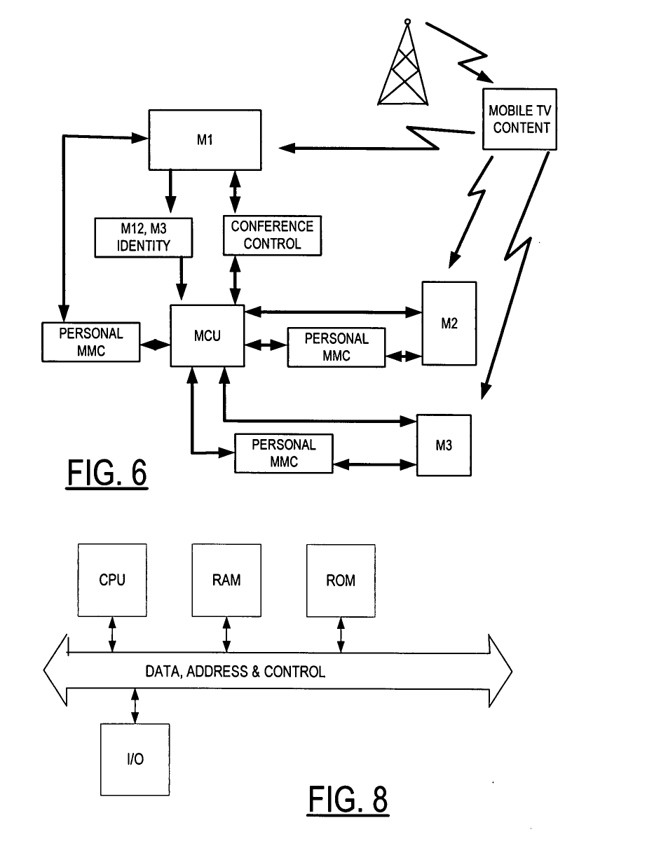

A fourth example is present with reference to FIG. 6 showing a multi-point conferencing unit configured and arranged for inviting participants identified by a single participant for sharing personal multimedia content among and between the participants in the Virtual TV room each of which receives the same Mobile TV content from a broadcast/multicast source. In this example participant M1 receives the ESG with the “public” section of the SIP URI of the MCU and has previously obtained or received in a suitable manner the “private” section of the SIP URI of the MCU.

Participant M1 then forms the complete SIP URI of the MCU by concatenating the “public” and “private” sections. Participant M1 now selects the SIP URI's of participant's M2 and M3 from M1's address book. Participant M1 interacts with the MCU in a suitable manner to set up a SIP session with participants M2 and M3 and conveys the required information to the MCU by using conference control protocols such as, for example, CCCP.

The required information provided to the MCU may include for example, the identities of participants M2 and M3 (e.g. the SIP URI's of M2, M3), the start-time and end-time of the Virtual TV Room session, etc. and other appropriate information as necessary to set up the SIP session. Participant M1 may also convey this information to the MCU by any other suitable means to carry out the intended function such as, for example, by uploading this information via HTTP to a server, which in turn relays this information to the MCU. Participant M1 may also convey this information to the MCU via interaction schemes that are proprietary to the service provider network.

The MCU then invites participants M2 and M3 to join the session and at the same time also informs participants M2 and M3 to tune into the same mobileTV channel. Participants M1, M2, M3 are now part of a private conference through the MCU and also respond to the MCU and tune into the same mobileTV channel.

The participants M1, M2, M3 may also share their personal multimedia content with each other through the MCU in addition to receiving the mobile TV content. Such personal multimedia content may consist of, for example, live a/v feed, stored a/v clips, etc. or other such multimedia content well known to those skilled in the art.

The MCU may mix and format the incoming content (personal media content received from participants M1, M2, M3) in any suitable and desirable layout.

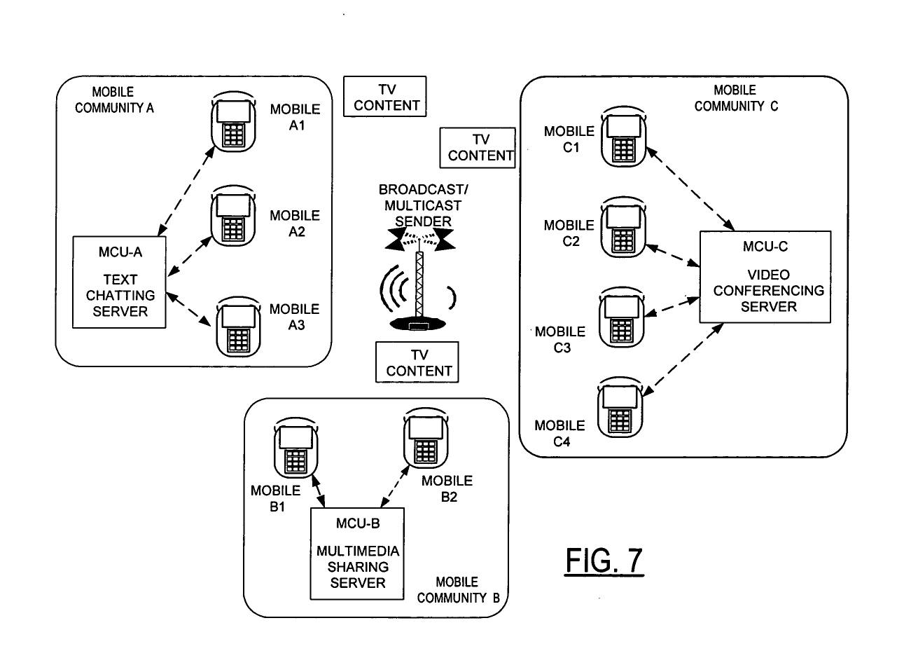

A schematic functional diagram of another example of the Virtual Room Service is shown in FIG. 7 in which participants are shown in respective different interactive user communities. In this example, participants in the Virtual TV rooms receive mobile TV services and share personal multimedia content. As shown in mobile community A, participants A1, A2, and A3 receive mobile TV content from a broadcast/multi-cast source on their respective mobile devices. The participants A1, A2 and A3 are set-up in a session in a similar manner as described above with a multi-point conferencing unit, which in community A functions, for example, as a text chatting server, such that the participants A1, A2 and A3 share each other's personal multimedia content, while watching the same mobile TV content.

As shown in mobile community B, participants B1 and B2 receive mobile TV content from a broadcast/multi-cast source on their respective mobile devices. The participants B1 and B2 are set-up in a session in a similar manner as described above with a multi-point conferencing unit, which in this community functions for example, as a multimedia sharing server, such that the participants B1 and B2 share each other's multimedia content, personal or otherwise, while watching the same mobile TV content.

As shown in mobile community C, participants C1, C2, C3 and C4 receive mobile TV content from a broadcast/multi-cast source on their respective mobile devices. The participants C1, C2, C3 and C4 are set-up in a session in a similar manner as described above with a multi-point conferencing unit, which in this community functions, for example, as a video conference server such that the participants C1, C2, C3 and C4 share each other's video multimedia content while watching the same mobile TV content.

In each of the respective mobile communities A, B and C, the participants may be located at geographically different locations, however, the participants in each of the respective mobile communities have the same experience as though each were located within the same room by virtue of the virtual TV room service embodying the present invention.

The mobile devices and multi-point conferencing units described in connection with the Virtual TV Room service are suitably arranged and configured to carry out the intended functions in accordance with the present invention.

In the examples above illustrating the basic formation of the Virtual TV room in a Virtual TV Room service, extensive application layer signaling is required among the participants and the network elements. The currently known and used protocols are not suitable to implement the Virtual TV Room service as contemplated by the present invention. An efficient signaling mechanism for use in forming the Virtual TV room sessions and providing the operational interactive and media control features of the Virtual TV room service is disclosed in the following discussion.

In the Virtual TV room concept, when the participant who wishes to share the multimedia content that is stored on his mobile device, the participant would either upload the content to the conference server (which is providing the multiparty video conferencing service) or could directly send the content as a stream which the conference server would route to the other participants of the conference. However, in this type of interactive multimedia session, no mechanism exists for media control by which the participant receiving the shared content can control the stream, that is for example, pause, rewind, fast forward, stop, etc. Only the sending participant has the control capability to execute all of these media control commands.

Also, the participant who is setting up the conference and who wants to share the content could specify the control commands (such as for example, play, fast forward, rewind, pause, resume, and stop) that it supports during this multimedia real-time/sharing session. The controls supported by the server and participant (client) are specified in an XML file which is communicated during the session set up.

A current protocol that is used for session control and media control in multimedia streaming applications is identified as RTSP, which is an IETF protocol. The RTSP protocol has been adopted into mobile multimedia streaming services such as for example 3GPP PSS and 3GPP2 MSS. In an RTSP streaming session, the client (the server is the media sender) can send RTSP messages such as, for example; play, pause, rewind, etc. to the server to control the media stream that the server is receiving.

Another current protocol that is used protocol for session setup and session control operations of multimedia conferencing applications is identified as SIP, which is also an existing IETF protocol. The SIP protocol has also been adopted in 3GPP and 3GPP2 standards for setup and control of mobile multimedia telephony sessions over IMS. For the Virtual TV Room service concept described above, the choice for the control protocol (setting up the multiparty interactive conferencing session with the TV content) would be SIP, however SIP does not provide any mechanism to control the media during the streaming session with the streaming commands such as for example, Play, Pause, Fast-forward, etc. that is provided by RTSP. However, if SIP is used as the control protocol to set up the session, setting up another RTSP session for the media control would not be possible or feasible because RTSP not only provides media control but also provides session control which would duplicate the session control already provided by SIP. Hence a new signaling mechanism, based on the current existing standards, for example, OMA BCAST ESG and IETF SIP, is needed to specify the media control commands that are supported by the server in a streaming session.

At the present time, the IETF XCON working group has prepared two text drafts identified as “draftjennings-xcon-media-control-03.txt” and “draft-boulton-xcon-media-template-02.txt”, respectfully which discuss the concept of indicating the capabilities of a multiparty conferencing server's media capabilities and which draft texts are incorporated herein by reference. These drafts propose the use of templates, which are XML documents, to specify the media capabilities of a conference server. Different templates are specified for different conference scenarios such as for example, basic audio conference, multimedia conference, etc. By using the templates, the end terminal client of a multiparty audio/video conference may display an appropriate GUI to the participant of the conference. However, the work in XCON is directed to multiparty audio/video conferencing and is not suitable for use in the Virtual TV room service concept of the present invention.

A framework for interaction between users and SIP applications has been described in an Internet draft ID, identified as “draft-ieff-sipping-app-interaction-framework-05” the text of which is incorporated herein by reference. The focus in this draft is on stimulus signaling which allows a user agent to interact with an application without knowledge of the semantics of that application. The information in the draft is presented for reference purposes only to assist the reader in gaining a better understanding of SIP.

It should be noted that the XML that specifies the controls specifies the controls only for the live or the recorded content. There can be provision for media control for the real time audio/video session that is sent by the participants to the conference server, however these provisions are beyond the present disclosure and not discussed herein.

As mentioned above, the XML file that describes the media control commands for the Virtual TV Room service session is signaled during the session set up. The end terminal software can render an appropriate GUI for the controls that are being offered in a particular session. The end terminal software can assign on a mobile phone certain keys for certain commands, for example, the joy stick keys are assigned for Forward, Rewind, Play and Pause. In another example, the XML file could specify mapping of certain keys to certain functions such as for example, 1 for fast-forward, 2 for rewind, 3 for pause, etc.

During the session set up, the conference server (or the mobile device which is sharing the content) signals the XML which specifies the media control commands the conference server supports for the session. The XML file may be represented in any suitable manner to carry out the intended function and several examples of how the XML file may be represented are presented below for purposes of illustration. The examples presented are not intended to be all inclusive or to be optimal for the intended function and accordingly the XML file examples are shown by way of illustration and not limitation.

In a first example for an XML file, the Media_Control_Commands element consists of multiple elements of Control. The control element has two attributes—Name and Enable. The Name attribute specifies the name of the command. The Enable attribute, if set to “true” means this command is supported and if set to “false” means the command is not supported. This is a very simple way to specify the XML. The end point can display the GUI and assigns keys on the mobile device anyway it deems fit. The protocol from the end point to the server is not part of the present invention but could for example send back the Name of the command itself and specify some parameters.

```
<?xml version=“1.0” encoding=“utf-8” ?>
<Media_Control_Commands>
  <Control Name=”Fast-Forward” enable=”true” />
  <Control Name=”Rewind” enable=”true” />
  <Control Name=”Pause” enable=”true” />
  <Control Name=”Play” enable=”true” />
  <Control Name=”Stop” enable=” true”/>
</Media_Control_Commvfdfdfands>
```

In a second example for an XML file, two more attributes are defined in addition to the Name and the Enable attribute, the Value and the Mapping_Key attribute.

The Value attribute specifies the value for the control mnemonic that the end client should use when sending the command to the server. For example, when the client needs to do a fast-forward it should send the value of 1 for this command. Other parameters that need to be sent would be defined in the protocol for the media control. An example of such another parameter would be the offset parameter for the fast-forward from the pointwhere the playing of the stream should start.

The Mapping_Key attribute specifies the mapping the end client should use for each command on the end device, for example, a mobile device or PDA. To illustrate in the example below, the fast-forward command is mapped to the right key of the joy stick of the mobile device. The advantage of this approach is that the user experience is same when this mechanism is used for different applications.

```
<?xml version=″1.0″ encoding=″utf-8″ ?>
<Media_Control_Commands>
  <Control Name=”Fast-Forward” enable=”true” value=”1”
Mapping_Key =”Right_Key” />
  <Control Name=”Rewind” enable=”true” value=”2”
Mapping_Key=”Left_Key” />
  <Control Name=”Pause” enable=”true” value=”3”
Mapping_Key=”Top_Key” />
  <Control Name=”Play” enable=”true” value=”4”
Mapping_Key=”Bottom_Key” />
  <Control Name=”Stop” enable=”true” value=”5”
Mapping_Key=”Center_Key” />
</Media_Control_Commands>
```

It should be noted that it is possible that only one participant of the conference has the right to use the media control commands during the Virtual TV Room session. In this case all the participants are watching the same content and synchronization is maintained, using for example a floor control protocol as defined in XCON.

It should also be noted that the transport protocol for the signaling of the XML file for the control commands or a mechanism for how to transport the control commands from the end participant to the server has not been specified herein as the transport itself is not part of the invention. The transport may however for example be HTTP, RTCP or a new unspecified protocol.

The interactions between the major logical functions should be obvious to those skilled in the art for the level of detail needed to gain an understanding of the concept of the present invention. It should be noted that the concept of the invention may be implemented with an appropriate signal processor such as shown in FIG. 8, a digital signal processor or other suitable processor to carry out the intended function of the invention,

Turning now to FIG. 9, a schematic functional block diagram of a UE or mobile terminal is illustrated therein showing the major operational functional components which may be required to carry out the intended functions of the mobile terminal and implement the concept of the invention. A processor such as the signal processor of FIG. 8 carries out the computational and operational control of the mobile terminal in accordance with one or more sets of instructions stored in a memory. A user interface may be used to provide alphanumeric input and control signals by a user and is configured in accordance with the intended function to be carried out. A display sends and receives signals from the controller that controls the graphic and text representations shown on a screen of the display in accordance with the function being carried out.

The controller controls a transmit/receive unit that operates in a manner well known to those skilled in the art. The functional logical elements for carrying out the MBMS operational functions are suitably interconnected with the controller to carry out the MBMS P-T-M transmission/reception as contemplated in accordance with the invention. An electrical power source such as a battery is suitably interconnected within the mobile terminal to carry out the functions described above. It will be recognized by those skilled in the art that the mobile terminal may be implemented in other ways other than that shown and described.

The invention involves or is related to cooperation between elements of a communication system. Examples of a wireless communication system include implementations of GSM (Global System for Mobile Communication) and implementations of UMTS (Universal Mobile Telecommunication System). These elements of the communication systems are exemplary only and does not bind, limit or restrict the invention in any way to only these elements of the communication systems since the invention is likely to be used for B3G systems. Each such wireless communication system includes a radio access network (RAN). In UMTS, the RAN is called UTRAN (UMTS Terretrial RAN). A UTRAN includes one or more Radio Network Controllers (RNCs), each having control of one or more Node Bs, which are wireless terminals configured to communicatively couple to one or more UE terminals.

The combination of an RNC and the Node Bs it controls is called a Radio Network System (RNS). A GSM RAN includes one or more base station controllers (BSCs), each controlling one or more base transceiver stations (BTSs). The combination of a BSC and the BTSs it controls is called a base station system (BSS).

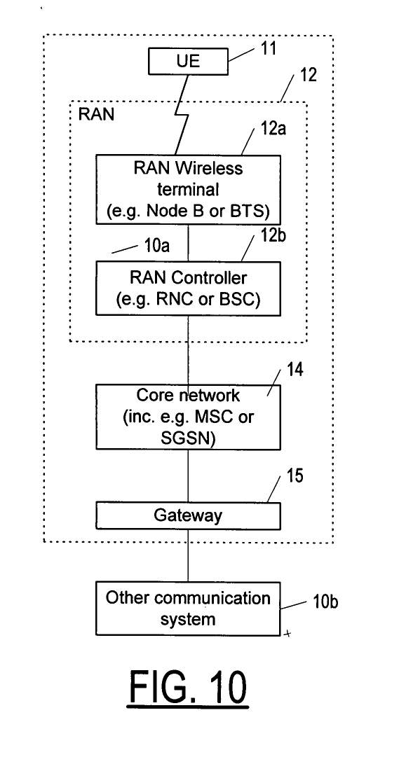

Referring now to FIG. 10, a wireless communication system 10a in which the present invention may be implemented is shown, including a UE terminal 11, a radio access network 12, a core network 14 and a gateway 15, coupled via the gateway to another communications system 10b, such as the Internet, wireline communication systems (including the so-called plain old telephone system), and/or other wireless communication systems. The radio access network includes a wireless terminal 12a (e.g. a Node B or a BTS) and a controller 12b (e.g. a RNC or a BSC). The controller is in wireline communication with the core network. The core network typically includes a mobile switching center (MSC) for circuit-switched communication, and a serving general packet radio service (GPRS) support node (SGSN) for packet-switched communication.

FIG. 11 shows some components of a communication terminal 20, which could be either the UE terminal 11 or the RAN wireless terminal 12a of FIG. 10. The communication terminal includes a processor 22 for controlling operation of the device, including all input and output. The processor, whose speed/timing is regulated by a clock 22a, may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 26 via a TRX interface 25 including possibly one or more digital signal processors (DSPs), application specific integrated circuits (ASICs), and/or field programmable gate arrays (FPGAs). The TRX enables communication over the air with another similarly equipped communication terminal.

Still referring to FIG. 11, the communication terminal includes volatile memory, i.e. so-called executable memory 23, and also non-volatile memory 24, i.e. storage memory. The processor 22 may copy applications (e.g. a calendar application or a game) stored in the non-volatile memory into the executable memory for execution. The processor functions according to an operating system, and to do so, the processor may load at least a portion of the operating system from the storage memory to the executable memory in order to activate a corresponding portion of the operating system. Other parts of the operating system, and in particular often at least a portion of the BIOS, may exist in the communication terminal as firmware, and are then not copied into executable memory in order to be executed. The booting up instructions are such a portion of the operating system.

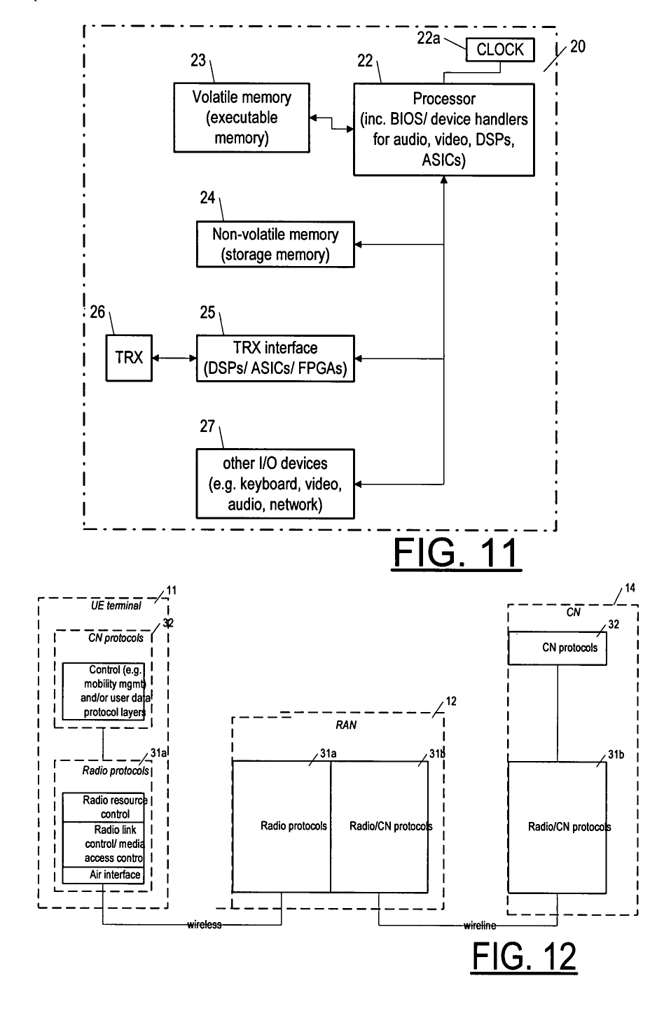

Referring now to FIG. 12, the wireless communication system of FIG. 10 is shown from the perspective of layers of a protocol according to which communication is performed. The layers of protocol form a protocol stack, and include CN protocol layers 32 located in the UE 11 and CN 14, and radio protocol layers 31a located in the UE terminal and in the RAN 12 (in either the RAN wireless terminal 12a or the RAN controller 12b). Communication is peer-to-peer. Thus, a CN protocol layer in the UE communicates with a corresponding layer in the CN, and vice versa, and the communication is provided via lower/intervening layers. The lower/intervening layers thus provide as a service to the layer immediately above them in the protocol stack the packaging or unpackaging of a unit of communication (a control signal or user data).

The CN protocols typically include one or more control protocol layers and/or user data protocol layers (e.g. an application layer, i.e. the layer of the protocol stack that interfaces directly with applications, such as a calendar application or a game application).

The radio protocols typically include a radio resource control (protocol) layer, which has as its responsibilities, among quite a few others, the establishment, reconfiguration, and release of radio bearers. Another radio protocol layer is a radio link control/media access control layer (which may exist as two separate layers). This layer in effect provides an interface with the physical layer, another of the radio access protocol layers, and the layer that enables actual communication over the air interface.

The radio protocols are located in the UE terminal and in the RAN, but not the CN. Communication with the CN protocols in the CN is made possible by another protocol stack in the RAN, indicated as the radio/CN protocols stack. Communication between a layer in the radio/CN protocols stack and the radio protocols stack in the RAN may occur directly, rather than via intervening lower layers. There is, as shown in FIG. 12, a corresponding radio/CN protocols stack located in the CN, allowing then communication between the application level in the UE terminal and the application level in the CN.

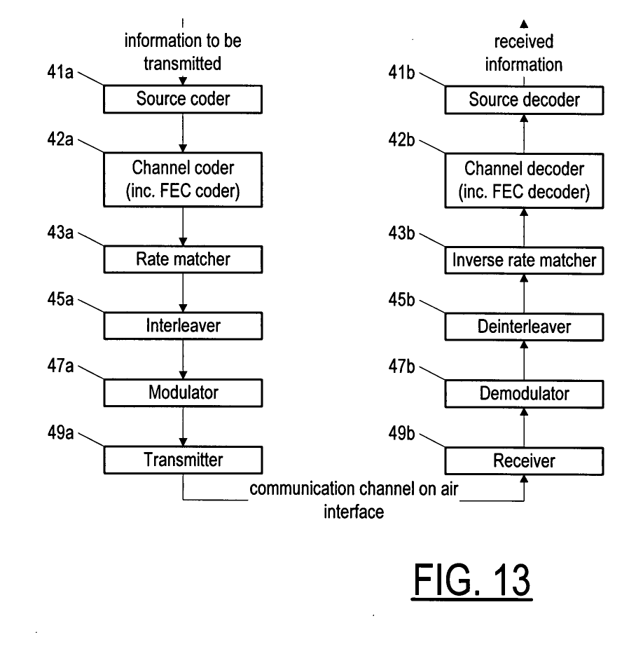

FIG. 13 is a reduced block diagram of the UE communication terminal 11 and the RAN wireless communication terminal 12a of FIG. 10, in terms of functional blocks corresponding to typically hardware (but in some cases software) equipment used in sending and receiving communication signals over a communication channel linking the two communications terminals 11 12a. Both typically include a source coder 41a responsive to information to be transmitted, and a corresponding source decoder 41b. The source coder removes redundancy in the information not needed to communicate the information. Both also include a channel coder 42a and a corresponding channel decoder 42b. The channel coder typically adds redundancy that can be used to correct error, i.e. it performs forward error correction (FEC) coding. Both communication terminals also include a rate matcher 43a and corresponding inverse rate matcher 43b. The rate matcher adds or removes (by so-called puncturing) bits from the bit stream provided by the channel coder, in order to provide a bit stream at a rate compatible with the physical channel being used by the communication terminals. Both communication terminals also include an interleaver 45a and a deinterleaver 45b. The interleaver reorders bits (or blocks of bits) so that strings of bits representing related information are not contiguous in the output bit stream, thus making the communication more resistant to so-called bursty errors, i.e. to errors from temporary causes and so that affect the communication for only a limited time, and so affect only a portion of the communicated bit stream.

Both communication terminals also include a modulator 47a and a demodulator 47b. The modulator 47a maps blocks of the bits provided by the interleaver to symbols according to a modulation scheme/mapping (per a symbol constellation). The modulation symbols thus determined are then used by a transmitter 49a included in both communication terminals, to modulate one or more carriers (depending on the air interface, e.g. WCDMA, TDMA, FDMA, OFDM, OFDMA, CDMA2000, etc.) for transmission over the air. Both communication terminals also include a receiver 49b that senses and so receives the communication terminal and determines a corresponding stream of modulation symbols, which it passes to the demodulator 47b, which in turn determines a corresponding bit stream (possibly using FEC coding to resolve errors), and so on, ultimately resulting in a providing of received information (which of course may or may not be exactly the transmitted information). Usually, the channel decoder includes as components processes that provide so-called HARQ (hybrid automatic repeat request) processing, so that in case of an error not able to be resolved on the basis of the FEC coding by the channel coder, a request is sent to the transmitter (possibly to the channel coder component) to resend the transmission having the unresolvable error.

The functionality described above (for both the radio access network and the UE) can be implemented as software modules stored in a non-volatile memory, and executed as needed by a processor, after copying all or part of the software into executable RAM (random access memory). Alternatively, the logic provided by such software can also be provided by an ASIC (application specific integrated circuit). In case of a software implementation, the invention is provided as a computer program product including a computer readable storage structure embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention as claimed herein.

The invention claimed is:

1. Method, comprising:
setting up a virtual TV room session in a virtual TV room service responsive to a unique session setup protocol between participants in the virtual TV room session and a conference server unit hosting the virtual TV room service such that each of the participants in the virtual TV room session is watching the same mobile TV channel.

2. The method as defined in claim 1 further comprising displaying the existence of a virtual TV room service associated with a mobile TV channel.

3. The method as defined in claim 2 further comprising providing the conference server unit with a unique identity for use in the session setup between the participants in the virtual TV room session and the conference server unit.

4. The method as defined in claim 3 further comprising defining the virtual TV room service as an attribute ServiceType of the Service fragment in an Open Mobile Alliance Broadcast Service.

5. The method as defined in claim 3 further comprising defining the unique identity of the conference server unit as an attribute type of the Access fragment in an Open Mobile Alliance Broadcast Service.

6. The method as defined in claim 3 further comprising setting the attribute type of the Access fragment as the Session Initiation Protocol Uniform Resource Identifier of the conference server unit.

7. The method as defined in claim 3 wherein the identity of the conference server unit is defined by a unique Session Initiation Protocol Uniform Resource Identifier consisting of a public portion and a private portion.

8. The method as defined in claim 7 further comprising forming the unique Session Initiation Protocol Uniform Resource Identifier of the conference server unit by concatenating the public portion and the private portion.

9. The method as defined in claim 8 further comprising concatenating the public portion of the Uniform Resource Identifier signaled in the electronic server/program guide for each mobile TV program, with the private portion of the Uniform Resource Identifier unique to each virtual TV room community.

10. The method as defined in claim 7 further comprising forming a Session Initiation Protocol session among the participants through the conference server unit via the unique Session Initiation Protocol Uniform Resource Identifier.

11. The method as defined in claim 7 further comprising signaling the public portion in the Access fragment of the Open Mobile Alliance Broadcast Electronic Service Guide.

12. The method as defined in claim 1 further comprising providing the capabilities of the media control that are available to the participants of the virtual TV room session.

13. The method as defined in claim 12 further comprising specifying the media controls in an XML file and communicating the XML file during the setting up of the virtual TV room session.

14. The method as defined in claim 3 further comprising:
the participants receiving the public portion of the Session Initiation Protocol Uniform Resource Identifier of the conference server unit signaled in the electronic server/program guide, each of the participants having the private portion of the Session Initiation Protocol Uniform Resource Identification unique to the virtual TV room community to which the participants belong;
a first one of the participants asking one or more of the other participants to join the conference related to the mobile TV channel; the participants forming the complete Session Initiation Protocol Uniform Resource Identifier in response to concatenating the public portion and the private portion of the Session Initiation Protocol Uniform Resource Identifier of the conference server unit;
the participants joining the private conference through the conference server unit; and
the first one of the participants tuning-in to the mobile TV channel for receiving the mobile TV content for sharing with the other participants in response to sending the mobile TV content to the conference server unit in unicast mode such that the participants receive the mobile TV content from the conference server unit.

15. The method as defined in claim 14 further comprising the participants sharing their respective personal multimedia content with one another through the conference server unit.

16. The method as defined in claim 15 further comprising the conference server unit mixing and formatting the mobile TV content from the first participant and the personal multimedia content in a desired layout.

17. The method as defined in claim 3 further comprising:
the participants receiving the public portion of the Session Initiation Protocol Uniform Resource Identifier of the conference server unit signaled in the electronic server/program guide, each of the participants having the private portion of the Session Initiation Protocol Uniform Resource Identification unique to the virtual TV room community to which the participants belong;
the participants forming the complete Session Initiation Protocol Uniform Resource Identifier in response to concatenating the public portion and the private portion of the Session Initiation Protocol Uniform Resource Identifier of the conference server unit;
the participants joining the private conference through the conference server unit; and
the participants tuning-in to the same mobile TV channel such that each of the participants is watching the same mobile TV content.

18. The method as defined in claim 17 further comprising the participants sharing their respective personal multimedia content with one another through the conference server unit.

19. The method as defined in claim 18 further comprising the conference server unit mixing and formatting the personal multimedia content in a desired layout.

20. The method as defined in claim 3 further comprising:
a first participant receiving the public portion of the Session Initiation Protocol Uniform Resource Identifier of the conference server unit signaled in the electronic server/program guide, the first participant having the private portion of the Session Initiation Protocol Uniform Resource Identification unique to a virtual TV room community;
the first participant forming the complete Session Initiation Protocol Uniform Resource Identifier in response to concatenating the public portion and the private portion of the Session Initiation Protocol Uniform Resource Identifier of the conference server unit;
the first participant selecting the Session Initiation Protocol Uniform Resource Identifier of other participants from a listing of participant Session Initiation Protocol Uniform Resource Identifiers;
the first participant interacting with the conference server unit for setting up a Session Initiation Protocol session with the selected participants in response to the first participant conveying the required information to the conference server unit;
all the participants forming a private conference through the conference server unit in response to the selected participants joining the session in response to an invitation from the conference server unit; and
the first participant tuning-in to the mobile TV channel for receiving the mobile TV content for sharing with the other participants in response to sending the mobile TV content to the conference server unit in unicast mode such that the other participants receive the mobile TV content from the conference server unit.

21. The method as defined in claim 20 further comprising the participants sharing their respective personal multimedia content with one another through the conference server unit.

22. The method as defined in claim 21 further comprising the conference server unit mixing and formatting the mobile TV content from the first participant and the personal multimedia content in a desired layout.

23. The method as defined in claim 3 further comprising:
a first participant receiving the public portion of the Session Initiation Protocol Uniform Resource Identifier of the conference server unit signaled in the electronic server/program guide, the first participant having the private portion of the Session Initiation Protocol Uniform Resource Identification unique to a virtual TV room community;
the first participant forming the complete Session Initiation Protocol Uniform Resource Identifier in response to concatenating the public portion and the private portion of the Session Initiation Protocol Uniform Resource Identifier of the conference server unit;
the first participant selecting the Session Initiation Protocol Uniform Resource Identifier of other participants from a listing of participant Session Initiation Protocol Uniform Resource Identifiers;
the first participant interacting with the conference server unit for setting up a Session Initiation Protocol session with the selected participants in response to the first participant conveying the required information to the conference server unit;
all the participants forming a private conference through the conference server unit in response to the selected participants joining the session in response to an invitation from the conference server unit; and
the selected participants tuning-in to the same mobile TV channel in response to the conference server unit identifying and informing the selected participants of the mobile TV channel such that each of the participants is watching the same mobile TV channel.

24. The method as defined in claim 23 further comprising the participants sharing their respective personal multimedia content with one another through the conference server unit.

25. The method as defined in claim 24 further comprising the conference server unit mixing and formatting the personal multimedia content in a desired layout.

26. A system, comprising:
a virtual TV room service configured with a virtual TV room session responsive to a unique session set-up protocol between participants in the virtual TV room session and a conference server unit hosting the virtual TV room service wherein the conference server unit is defined by a unique Session Initiation Protocol Uniform Resource Identifier formed by concatenating the public portion of the Session Initiation Protocol Uniform Resource Identifier signaled in the electronic server/program guide for the mobile TV channel and the private portion of the Session Initiation Protocol Uniform Resource Identifier unique to the virtual TV room community and arranged such that each of the participants in the virtual TV room session is watching the same mobile TV channel.

27. The system as defined in claim 26 arranged so that the mobile TV content is received by one of the participants for sharing with the other participants in the virtual TV room session through the conference server unit.

28. The system as defined in claim 26 arranged so that the participants in the virtual TV room session are tuned-in to the same mobile TV channel.

29. The system as defined in claim 25 further arranged so that the capabilities of media control that are available to the participants in the virtual TV room session are specified in an XML file configured for communication during the setting up of the virtual TV room session.

30. The system as defined in claim 25 further configured for sharing respective personal multimedia content among the participants in the virtual TV room session.

31. Apparatus, comprising:
a conference server unit hosting a virtual TV room service wherein the conference server unit is defined by a unique Session Initiation Protocol Uniform Resource Identifier formed by concatenating the public portion of the Session Initiation Protocol Uniform Resource Identifier signaled in the electronic server/program guide for the mobile TV channel and the private portion of the Session Initiation Protocol Uniform Resource Identifier unique to the virtual TV room community to which participants in a virtual TV room session belong wherein the virtual TV room service is configured with a virtual TV room session responsive to a unique session set-up protocol between participants in the virtual TV room session and the conference server unit and arranged such that each of the participants in the virtual TV room session is watching the same mobile TV channel.

32. The apparatus as defined in claim 31 further configured for specifying the capabilities of media control that are available to the participants in the virtual TV room session in an XML file configured for communication during the setting up of the virtual TV room session.

33. The apparatus as defined in claim 32 further arranged with a suitable signal processor for carrying out the intended operational functions of the virtual TV room service.

34. A computer program product comprising a computer readable storage structure embodying computer program code thereon for execution by a computer processor, wherein said computer program code comprises instructions for performing the method of setting up a virtual TV room session in a virtual TV room service according to claim 9.

35. An application specific integrated circuit configured for operation according to the method of setting up a virtual TV room session in a virtual TV room service according to claim 9.
